(19) United States
(12) Patent Application Publication
(10) Pub. No.: US 2003/0115113 A1
(43) Pub. Date: Jun. 19, 2003

(54) Method and apparatus for making recommendations

(76) Inventor: Ross W. Duncan, Blairgowrie (GB)

Correspondence Address: MICHAEL CHAN, NCR CORPORATION, 1700 SOUTH PATTERSON BLVD, DAYTON, OH, 45479-0001, US

(21) Appl. No.: 10/315,853

(22) Filed: Dec. 10, 2002

(30) Foreign Application Priority Data
Dec. 13, 2001 (GB) 0129795.1

(51) Int. Cl. G06F 17/60

(52) U.S. Cl. 705/26; 707/7

(57) ABSTRACT

A method of recommending goods or services to a user is described. The recommendations are made based on various data sources containing information of the user and the possible recommendations. A first recommendation is made to a user within a restricted time limit via a portable computing device such as a mobile telephone or a PDA, the time limit restricting the available sources of information which may be consulted to produce the recommendation. The user is then offered a second recommendation of improved accuracy; to achieve this the time limit is increased, so allowing additional data sources to be consulted. The second recommendation may be offered via a fixed computing device such as a self service terminal (SST), allowing greater bandwidth access to the data sources, and allowing additional services or information to be provided to the user, such as detailed information or images on the recommendations.

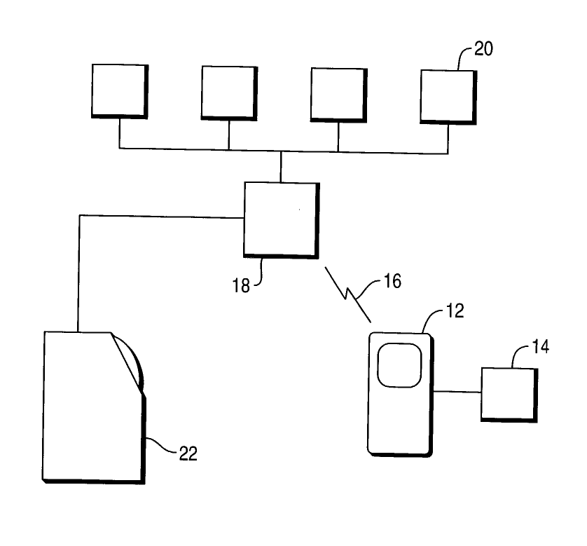

### BACKGROUND OF THE INVENTION

The present invention relates to a method for recommending products or services to a user based on information concerning the user's preferences. The invention further relates to a system for implementing such a method, and to various apparatus for use in the system. Selected aspects of the invention further relate to a method for recommending products or services to a user making use of remote data sources.

Numerous methods are known for recommending a particular type of product or service to a user on the basis of the user's past choices, or known preferences. This ‘data mining’ is an important aspect of marketing, and is also of assistance to the user, since it allows new products or services to be chosen on an informed basis. For example, supermarkets may use information gleaned from customer loyalty schemes to promote, say, a particular brand of French wine to customers who are known to have bought similar wines in the past. The supermarket obtains additional sales from the promotion, while the customer may discover a new product that they enjoy.

Similarly, a wide range of other suppliers may make use of their own databases to promote particular goods or services to a customer. The method may also be used in response to a direct query from a customer, rather than simply a promotion; for example, a customer may ask a bookseller to recommend a book for the customer to read; based on the bookseller's records of previous purchases by that customer, and their knowledge of which books have also been bought by other customers, a particular new book may be recommended to the customer.

Recommendations may also include a time or location-specific element in addition to simply user preferences: to take a very basic example, should a tour operator know that a customer will be in a particular city on a particular date, they may wish to recommend certain events to the customer based on their knowledge of previous events attended by the customer.

Particular methods of implementing such a recommendation system will be known to the skilled person; ranging from simple correlations between purchases, to sophisticated algorithms to predict future purchases. For the purposes of the present invention, and indeed for most recommendation systems, the precise implementation of the recommendation is not critical.

However, known recommendation systems may experience a number of difficulties which reduce the accuracy of their recommendations. Principal among these is the availability of information: information regarding a user's preferences may be stored in diverse locations, and the ability to access only a subset of this information, typically only the locally stored information, will reduce the accuracy of any recommendation. For example, if a user buys their wine from one supermarket, while buying the majority of their goods from another supermarket, the second supermarket will have very little information on which to base a wine recommendation.

However, it is clearly not practical to access all information on a user before making a recommendation; and even to attempt to access a restricted set of information may increase the processing time necessary to generate a recommendation. While a user may be willing to accept some increase in time to deliver a more accurate recommendation, this must depend on the importance of accuracy compared to speed for the particular user. Similarly, some users may be willing to accept less accurate recommendations if the recommendations may be made quickly. This may be particularly important when viewed in light of the recent growth in mobile communications and computing technology, since such users are more likely to wish to obtain recommendations quickly.

### SUMMARY OF THE INVENTION

It is among the objects of embodiments of the present invention to obviate or alleviate these and other disadvantages of known recommendation methods. In certain embodiments of the invention, this is achieved at least in part by a method which allows a relatively rapid but less accurate recommendation to be made, followed by a second more accurate recommendation some time later, should the user wish it.

Certain embodiments of the present invention make use of two concepts to allow a user to judge the reliability of a recommendation, and to determine whether or not to obtain a second recommendation. The first is the confidence of the recommendation; usually expressed as a percentage, this indicates the accuracy of the recommendation. Suitable algorithms for calculating the confidence will be known to the skilled person. The second concept is the measure of information used; again this is usually expressed as a percentage, and will relate to the amount of information used to arrive at the recommendation compared with the total amount of relevant information available. Of course, the two concepts are interlinked to some extent, and the confidence of a recommendation will usually increase as the information used increases; it will however be apparent that other factors may affect the values of the two measures, and more information may not necessarily increase the confidence of a recommendation being accurate.

According to a first aspect of the present invention, there is provided a method of recommending goods or services to a user, the method comprising the steps of: a) determining the types of goods or services to be recommended; b) determining a time limit within which to retrieve information on which to base a recommendation; c) determining one or more sources from which to retrieve said information, given the determined types of goods or services and the time limit; d) accessing the determined sources and retrieving said information within said time limit; e) determining a recommendation to make based on the retrieved information; f) determining a confidence measure (CP) and an information used measure (IP) associated with the determined recommendation; g) informing a user of the recommendation, the CP, and the IP; h) offering the user the opportunity of obtaining an improved recommendation; and if the user requests an improved recommendation, altering the time limit, and repeating steps c) to g) to make an improved recommendation.

Thus, the present invention allows a user to obtain a first recommendation within a restricted time limit, and subsequently to obtain an improved recommendation using more information sources within an increased time limit. Informing the user of the confidence of the recommendation allows the user to make an informed judgement as to whether or not to request the improved recommendation. The CP and IP may be combined before informing the user of a combined measure of the two variables, if desired.

It will also be apparent that the present invention allows the first recommendation to be based on a restricted set of information sources (for example, only local sources), while the improved recommendation may make use of a range of remote information sources, which will require additional time.

The step of determining the type of products or services to be recommended may comprise responding to a request from a user for a particular type of product of service. The request may be direct (for example, ‘a vegetarian Indian restaurant in Glasgow’), or may be the result of a series of navigated choices on the part of the user (such as, for example, would result from a hierarchical or ‘tree’ navigation structure).

The time limit may be selected by the user, either directly or indirectly, for example by selecting a desired CP for the recommendation, which will direct the determination of an appropriate time limit in which the requested CP may be expected to be obtained. Alternatively, the time limit may be predetermined before the user request is made; for example, the initial recommendation may be restricted to have a time limit of, say, ten seconds, while time limits for subsequent recommendations may be user-selectable, or governed by the time when the products or services are required.

The sources to access may be predetermined for a particular time limit, for example, or may be selected for each recommendation. For example, which sources may be accessed within a particular time limit may vary depending on network traffic (if the source is a remote source), location with respect to the source, and current processing demands on the source. These factors may be determined to allow selection of the sources to access within the time limit. The sources may be selected from a list or other record of sources to be used. Local and remote sources may either or both be used; for example, a relatively small database may be held locally by a user, for example within their mobile telephone or PDA, and accessed to make an initial recommendation, while subsequent recommendations may make use of more comprehensive databases held remotely. Different sources may be accessed depending on the type of recommendation sought.

Preferably, the first recommendation is given on a portable computing device; for example, a mobile telecommunications device, a personal digital assistant (PDA), a portable computer, or the like. Preferably also all of steps a) to h) in the first recommendation are performed on the portable computing device; although in certain embodiments of the invention only the user interaction steps a), b), g), and h) may be performed on the portable computing device, with the remaining processing steps performed on a remote server or the like.

Preferably the second recommendation is given on a fixed computing device, more preferably on a self-service terminal (SST) or the like. Preferably also all of the steps of the subsequent recommendation are performed on the fixed computing device. This allows the user to rapidly obtain the first recommendation while mobile, while the second recommendation, which may take some time to prepare, may be given to the user at a fixed device. This has the advantage that the fixed device is likely to have a better user interface, more peripherals providing enhanced functionality, greater processing power and communications bandwidth than a mobile device, and so will be more suited to determining a more accurate recommendation.

The method may further comprise the step of offering the user a choice of fixed computing devices on which to receive subsequent recommendations. For example, the user may elect to receive the recommendation at the nearest SST to their current location; alternatively, if the user knows they will be at a certain location at a certain time, they may choose an SST near to that location. By choosing a particular SST in advance, the SST may be able to pre-load any information (for example, a large graphical image) that would otherwise have to be loaded while the user was present at the SST. The current location of the user may be determined in a straightforward manner, if the initial recommendation is given on a mobile telecommunications device. The choices of SST given may be restricted before offering them to the user. For example, if the user requests a recommendation for a city center restaurant for that evening, the subsequent recommendation may be given at a choice of city center SSTs, even if the current location of the user is elsewhere in the city.

Where subsequent recommendations are given on a fixed computing device such as an SST, the method may further comprise offering the user additional information or services via the SST. For example, reservations may be made for restaurants, payment made for certain goods or services using the SST's financial interface, or high-bandwidth information such as videos or graphics-intensive world wide web pages may be made available to the user.

Subsequent recommendations may also be given on the same computing device as used for the initial recommendation, rather than an SST. For example, periodic refinements of the initial recommendation may be delivered to a mobile communications device if desired.

According to a second aspect of the present invention, there is provided a method of recommending goods or services to a user, the method comprising the steps of:

a) determining the types of goods or services to be recommended;

b) determining a time limit within which to retrieve information on which to base a recommendation;

c) determining one or more sources from which to retrieve said information, given the determined types of goods or services and the time limit;

d) accessing the determined sources and retrieving said information within said time limit;

e) determining a recommendation to make based on the retrieved information;

f) informing a user of the recommendation;

g) offering the user the opportunity of obtaining an improved recommendation; and

h) if the user requests an improved recommendation, altering the time limit, and repeating steps c) to f) to make an improved recommendation.

This aspect of the present invention allows a user to obtain successively more reliable recommendations within the allowed time limit, but does not require the calculation of the CP or IP. The user will not of course be able to determine the reliability of the recommendation, however the method relies on the likelihood of obtaining an improved recommendation simply as a result of the increased time limit. The method may of course further comprise any or all of the steps of determining the CP and/or the IP of the recommendation, and/or informing the user of the CP and/or the IP of the recommendation.

According to a third aspect of the present invention, there is provided a method of recommending goods or services to a user, the method comprising the steps of:

a) determining by means of a mobile computing device the types of goods or services to be recommended;

b) determining by means of the mobile computing device a time limit within which to retrieve information on which to base a recommendation;

c) determining by means of the mobile computing device one or more sources from which to retrieve said information, given the determined types of goods or services and the time limit;

d) accessing the determined sources and retrieving to the mobile computing device said information within said time limit;

e) determining by means of the mobile computing device a recommendation to make based on the retrieved information;

f) determining by means of the mobile computing device a confidence measure (CP) and an information used measure (IP) associated with the determined recommendation;

g) informing a user by means of the mobile computing device of the recommendation, the CP, and the IP;

h) offering the user by means of the mobile computing device the opportunity of obtaining an improved recommendation; and

i) if the user requests an improved recommendation, transferring details of the determined information to a fixed computing device, altering the time limit, and repeating steps c) to g) using the fixed computing device instead of the mobile computing device to make an improved recommendation.

Preferably the fixed computing device is a self-service terminal (SST).

According to a further aspect of the present invention, there is provided a method of recommending goods or services to a user, the method comprising the steps of:

a) determining by means of a mobile computing device the types of goods or services to be recommended;

b) determining a time limit within which to retrieve information on which to base a recommendation;

c) transferring the determined time limit and type of information to a remote server;

d) using the remote server to determine one or more sources from which to retrieve said information, given the determined types of goods or services and the time limit;

e) accessing the determined sources and retrieving said information to the remote server within said time limit;

f) determining by means of the remote server a recommendation to make based on the retrieved information;

g) determining by means of the remote server a confidence measure (CP) and an information used measure (IP) associated with the determined recommendation;

h) transferring the recommendation, the CP, and the IP to the mobile computing device, and informing a user by means of the mobile computing device of the recommendation, the CP, and the IP;

i) offering the user the opportunity of obtaining an improved recommendation; and

j) if the user requests an improved recommendation, altering the time limit, informing the user of a location of a fixed computing device by which to access an improved recommendation, and repeating steps c) to h), using the fixed computing device instead of the mobile computing device to make an improved recommendation.

This aspect of the invention allows the processing steps to be performed remotely from the computing device, for example by means of a remote server, thus freeing some of the computational burden from the mobile computing device.

According to a still further aspect of the present invention, there is provided a system for recommending goods or services to a user, the system comprising: at least one mobile computing device and at least one fixed computing device, each comprising: a user interface including means for data input and means for data output; computer processing means for processing data to determine recommended goods or services, a confidence measure, and an information used measure; computer memory means for storing input, output, and working data; and communications means for transmitting and receiving data to and from remote locations, including the other of the fixed or mobile computing device and databases; and at least one database means for storing information regarding users, goods, and/or services and for providing data to the mobile and fixed computing devices.

The database means may be provided as a component of either or both of the fixed and mobile computing devices, and/or as a remote database held elsewhere.

The system may further comprise a remote server for receiving and co-ordinating transfer of data between the fixed and mobile computing devices, and the database means.

According to a yet further aspect of the present invention, there is provided a method of operating a system for recommending goods or services to a user, the method comprising the steps of:

providing one or more databases containing information regarding users, goods, and/or services;

allowing users to access the databases by means of mobile computing devices, and/or fixed computing devices, to determine goods or services to recommend; and

charging the users for access to the databases.

The method may further comprise the step of charging the users different rates depending on which databases are accessed; charging may also be performed on a flat-rate or per use rate. A single database may effectively comprise a plurality of databases by dividing the data within the database into a number of categories, and allowing differential access, and possibly charging differential rates, for access to each category of data.

The step of providing the databases may include simply providing access for users to databases, the physical implementation of which is provided by third parties.

The method may further comprise the step of charging third parties for inclusion of specific details in the database. Differential charges may also be levied for this step, depending on which of the databases the details are included in, or on the amount or relevance of details included.

The method may still further comprise the step of providing advertisements, sponsored information, or the like to certain users. This further information may be provided selectively; for example, restaurant advertisements may be provided only to users who request recommendations of restaurants; or the advertisements may be geographically restricted. Certain of the further information may further be restricted to users accessing the database through certain computing devices only—for example, high-bandwidth video or graphics information may be provided only to users accessing the database through a fixed computing device.

The users may also be charged differentially depending on their access method : for example, users accessing the databases through fixed computing devices may be charged lower rates than mobile users. This provides an incentive for users to access fixed terminals for recommendations, which allows more advertisement and other information to be provided, so offsetting the cost by increased advertising revenue.

The method may yet further comprise the step of offering additional goods or services to users through fixed computing devices; for example, payment or reservation services, and the like.

### BRIEF DESCRIPTION OF THE DRAWINGS

These and other aspects of the present invention will now be described by way of example only, and with reference to the accompanying Figure, which shows a schematic representation of a system for recommending goods or services to a user, in accordance with an embodiment of the invention.

### DETAILED DESCRIPTION

The Figure shows a personal digital assistant (PDA) 12, which includes local memory storage 14. The PDA 12 has a wireless communications link 16 to a remote server 18. The server 18 has access to a range of different databases 20, each of which may be provided by a different database provider. For example, the databases may include supermarket loyalty scheme information, records of the user's preferred leisure activities and the like, a travel guide, and internet purchasing information. The server 18 is also connected, by a high-bandwidth fixed connection, to a self service terminal (SST) 22. Only one SST 22 is shown here, although typically a whole SST network may be available.

To obtain a recommendation, the system is used as follows. The user firstly accesses the PDA 12, and requests a recommendation for a particular service—say, a local wine bar. The PDA 12 is programmed to treat all initial queries as rapidly as possible, and so determines a ten-second time limit applies to this query. Information on the query and the time limit are transferred to the remote server 18, together with information on the current location of the PDA 12 which may be obtained from the communications service provider. The server 18 then proceeds to retrieve data on wine bars in the local area together with known wine preferences of the user from as many of the databases 20 as respond within the ten-second time limit. This information is then returned to the PDA 12, together with information on the confidence weighting of each information source, and details of the databases accessed.

In the meantime, the PDA 12 may also have been retrieving locally-stored data from the local memory 14. For example, personal details of the user and their preferences may be stored on the PDA, together with a previously-loaded map and guide to the local area.

All the retrieved data is then analyzed by the PDA 12, using known recommendation algorithms, to arrive at a recommendation for the user, together with ratings for a confidence measure (CP) and extent of information used measure (IP). The PDA 12 then informs the user of the recommended wine bar, together with details of the CP and IP, expressed as percentages. The user is then offered the opportunity of obtaining a more reliable recommendation in, say, an hour's time from the SST 22. The PDA 12 may display a map showing the location of the SST 22. If the user agrees, this acceptance is transferred to the SST 22 via the server 18.

The SST 22 then proceeds to determine an updated recommendation in much the same manner as the PDA 12, although since more time is available, more databases 20 can be accessed. When the user arrives at the SST 22 an hour later, they identify themselves to the SST 22 by presenting their conventional SST card. The SST 22 then provides the list of top five recommended wine bars, together with further high-bandwidth information on each of the recommendations provided from the databases—for example, the range of wines available, video images of the bars, sample food menus if food is available, reviews from guidebooks, and so on. Certain of the bars may also provide incentives for visiting—for example, reduced prices and the like. The system operator may charge businesses for making such incentives available.

Should the user wish to visit one of the wine bars, the location may be checked via the SST 22 and a conventional internet connection or the like, and a hard copy printed out, or transferred to the user's PDA 12. The user may also wish to pre-order a particular favorite type of wine, and details of the order and the user's SST card are passed to the wine bar to make the order, and the user proceeds on their way.

It will be understood that various modifications may be made to the example herein described. For example, although in this example, the databases are accessed via a server 18, the system may be decentralized, and databases may be accessed directly by the PDA 12 or the SST 22. Further, various of the steps herein described may be offered as one of a range of options to the user—for example, a choice of nearby SSTs or times may be offered for obtaining the second recommendation; or the recommendation may be sent to the PDA 12 rather than the SST 22; in this case much of the high-bandwidth information and/or some of the functionality may not be available for the second recommendation. The system operator may wish to levy different charges for accessing the recommendations in different locations or manners.

A further example of the method of the present invention being used will now be described. A user is visiting Madrid, and is unfamiliar with the city. In the afternoon, on the way to the Prado Museum, the user wishes to find a restaurant in which to dine in the evening. Using a PDA, the user accesses the recommendation service, and requests a restaurant recommendation. The request is passed to a server, which identifies the user's location by means of the PDA. The server then gathers available information on restaurants and on the user within a ten second time limit. Specifically local information is also accessed, for example, the local tourist office. The information is then returned to the PDA, which determines a recommended restaurant. The recommendation is given to the user, with a 75% confidence rating, based on 70% of available information.

The PDA also stores the user's daily activities calendar, and identifies that the user will be in the museum for the next two hours, after which the user intends to go into the city center. The PDA thus offers the user the choice of improving the recommendation either periodically, via the PDA, by accessing the nearest SST (the location of which is displayed on a map on the PDA), or after the user has visited the museum via an SST adjacent the museum. The user selects the third option, and proceeds to visit the museum. Details of the user's selection are then transferred by the PDA to the server.

While the user is in the museum, the server accesses a list of restaurants categorized by cuisine type, together with sample menus and availability from the local tourist office database. Further information on the user's habits and activities on previous foreign trips are also obtained from a database maintained by the user's home communications service provider, from which it is determined that the user likes to eat local cuisine when abroad.

Upon leaving the museum, the user accesses the PDA to confirm the location of the nearest SST, and proceeds to access that SST. An updated recommendation is presented with 90% confidence based on 95% of the available information. The recommendation differs from the original one due to information on the user's food likes and dislikes, and based on table availability from the tourist office. A sample menu is also shown.

Additional, less highly rated recommendations are also displayed, together with icons indicating further information such as videos, on-line booking, and special offers. The user reads this information, and decides to choose the second recommendation, as a price reduction is available, and the video clip of the interior of the restaurant looks appealing.

The restaurant does not, however, have an on-line booking system, and so the user selects an option for the restaurant to telephone him. The restaurant discusses times, and specials of the day with the user, and confirm the reservation. Whilst talking with the restaurant, the user instructs the SST to print a map showing directions to the restaurant. The user finishes the transaction, and leaves the SST having made a reservation.

A number of possible charging schemes may be used with embodiments of the present invention, to allow the system provider to raise revenue from the recommendation service. For example, if the user is paying a per-data transmitted rate then a slight premium charge may be levied to provide revenue. In a cost per minute model, again a premium charge may also provide revenue.

Since a greater number of connections or databases will typically need to be accessed to improve recommendations, the charge may be increased as the IP increases. Services offered may be graded according to different market segments, or the user may select from different levels of service based on number of databases searched, or on subscription databases. The charges levied by the operator may include and reflect these increased operating costs.

Retailers and service providers may also be charged for inclusion of their information in the system. One possible model may be to charge retailers lower rates as they include more data in the system, since more data contributes to more accurate recommendations, allowing the end user to be charged an increased rate for accurate recommendations.

Organizations such as tourist services may recruit local businesses to appear on the system and aggregate information. Similar services may be provided by other groups of related or complementary businesses; for example, banks may recruit and host information on other financial services. The hosting organization may also levy a charge from smaller businesses for the hosting service.

The system may also raise revenue on a commission basis, with the system operator receiving a percentage of the funds spent by the user as a result of a recommendation; or a flat fee for each successful recommendation.

A further modification of the invention allows ‘communities of interest’ to be established and to provide services of interest to the community. For example, an interest community may be used by a system provider as a source of data to mine for recommendations through clustering; or the interest community may be the service provider to provide recommendations of interest to the community members. Such communities also allow advertising or recommendations to be more precisely targeted to the specific user group, allowing higher advertising or other revenue charges to be made.

In other embodiments, an identification token other than a card may be used, for example, a biometrics identifier, a smart button, or such like.

What is claimed is:

1. A method of recommending goods or services to a user, the method comprising the steps of:
a) determining the types of goods or services to be recommended;
b) determining a time limit within which to retrieve information on which to base a recommendation;
c) determining one or more sources from which to retrieve the information, given the determined types of goods or services and the time limit;
d) accessing the determined sources and retrieving the information within the time limit;
e) determining a first recommendation to make based on the retrieved information;
f) determining a confidence measure (CP) and an information used measure (IP) associated with the first recommendation;
g) informing a user of the first recommendation, the CP, and the IP;
h) offering the user the opportunity of obtaining a second recommendation which is an improved recommendation; and
i) if the user requests a second recommendation, altering the time limit, and repeating steps c) to g) to make a second recommendation.

2. The method of claim 1, wherein the first recommendation is given on a portable computing device.

3. The method of claim 2, wherein the second recommendation is given on a fixed computing device.

4. The method of claim 3, further comprising the step of:
j) offering the user a choice of fixed computing devices on which to receive subsequent recommendations.

5. The method of claim 3, further comprising the step of:
k) offering the user additional information or services via the fixed computing device.

6. A method of recommending goods or services to a user, the method comprising the steps of:
a) determining the types of goods or services to be recommended;
b) determining a time limit within which to retrieve information on which to base a recommendation;
c) determining one or more sources from which to retrieve the information, given the determined types of goods or services and the time limit;
d) accessing the determined sources and retrieving the information within the time limit;
e) determining a recommendation to make based on the retrieved information;
f) informing a user of the recommendation;
g) offering the user the opportunity of obtaining an improved recommendation; and
h) if the user requests an improved recommendation, altering the time limit, and repeating steps c) to f) to make an improved recommendation.

7. A method of recommending goods or services to a user, the method comprising the steps of:
a) determining by means of a mobile computing device the types of goods or services to be recommended;
b) determining by means of the mobile computing device a time limit within which to retrieve information on which to base a recommendation;
c) determining by means of the mobile computing device one or more sources from which to retrieve the information, given the determined types of goods or services and the time limit;
d) accessing the determined sources and retrieving to the mobile computing device the information within the time limit;
e) determining by means of the mobile computing device a recommendation to make based on the retrieved information;
f) determining by means of the mobile computing device a confidence measure (CP) and an information used measure (IP) associated with the determined recommendation;
g) informing a user by means of the mobile computing device of the recommendation, the CP, and the IP;
h) offering the user by means of the mobile computing device the opportunity of obtaining an improved recommendation; and
i) if the user requests an improved recommendation, transferring details of the determined information to a fixed computing device, altering the time limit, and repeating steps c) to g) using the fixed computing device instead of the mobile computing device to make an improved recommendation.

8. A system for recommending goods or services to a user, the system comprising:
at least one mobile computing device;
at least one fixed computing device;
each device comprising (i) a user interface including means for data input and means for data output, (ii) computer processing means for processing data to determine recommended goods or services, a confidence measure, and an information used measure, (iii) computer memory means for storing input, output, and working data, and (iv) communications means for transmitting and receiving data to and from remote locations, including the other of the fixed or mobile computing device and databases; and
at least one database means for storing information regarding users, goods, and/or services and for providing data to the mobile and fixed computing devices.

9. A method of operating a system for recommending goods or services to a user, the method comprising the steps of:
providing one or more databases containing information regarding users, goods, and/or services;
allowing users to access the databases by means of mobile computing devices, and/or fixed computing devices, to determine goods or services to recommend; and
charging the users for access to the databases.

10. The method of claim 9, further comprising the step of offering additional goods or services to users through fixed computing devices.
